(19) United States
(12) Patent Application Publication
(10) Pub. No.: US 2012/0274539 A1
(43) Pub. Date: Nov. 1, 2012

(54) DISPLAY APPARATUS, METHOD FOR CONTROLLING DISPLAY APPARATUS, AND STORAGE MEDIUM

(75) Inventors: Hirohiko Tashiro, Kawasaki-shi (JP); Hiroshi Tanioka, Yokohama-shi (JP); Yoshitaka Oba, Kawasaki-shi (JP); Masayuki Sato, Tokyo (JP); Kenji Hara, Kawasaki-shi (JP)

(73) Assignee: CANON KABUSHIKI KAISHA, Tokyo (JP)

(21) Appl. No.: 13/394,211

(22) PCT Filed: Nov. 22, 2011
(86) PCT No.: PCT/JP2011/077447

§ 371 Date: Mar. 5, 2012

(30) Foreign Application Priority Data
Nov. 30, 2010 (JP) 2010-267498
Nov. 11, 2011 (JP) 2011-247968

(51) Int. Cl. G09G 5/00

(52) U.S. Cl. 345/1.1

(57) ABSTRACT

It was necessary to prepare display data for the portrait and landscape display modes respectively, since the arrangement of the objects differs between the portrait and landscape display modes.

### TECHNICAL FIELD

The present invention relates to a display apparatus that can be attached to and detached from a main body of an image forming apparatus etc. and displays an operation screen etc. used to control the main body, a method for controlling the display apparatus, and a storage medium.

### BACKGROUND ART

Heretofore, there have been devices that achieve enhanced operability by making an operating panel equipped with a display apparatus used for controlling the main body of an image forming apparatus (hereinafter referred to as the main body) detachable from the main body of the image forming apparatus and thereby allowing for operations to be performed by looking at the operating panel removed from the main body. In addition, there are display devices effecting display by adaptively switching the direction of display in accordance with orientations produced by rotating the display apparatus in the portrait and landscape directions (Japanese Patent Laid-Open No. 11-30969).

While the display direction of an operating panel that can be attached to and detached from an image forming apparatus is fixed, for an operator, its operability might be further enhanced if it were possible to implement a display matching its operational direction. An image forming apparatus having a copying feature and a facsimile feature, etc., requires various setup operations. For this reason, this operating panel usually has a large rectangular touch panel and liquid crystal cells.

By contrast, the detachable display apparatus disclosed in Japanese Patent Laid-Open No. 11-30969 has a square-shaped shared first display area capable of display both in a portrait and landscape display modes and a second display area, in which the display mode varies between a portrait mode and a landscape display mode, with its operability shared in the portrait and landscape directions. However, since the arrangement of the objects in the second display area differs between the portrait and landscape display modes, display data has to be prepared respectively for the portrait and landscape display modes. In addition, there is the problem that for the user the panel is difficult to operate because of the difference in the arrangement of the items displayed in the second display area when the operating panel is used in the portrait display mode and when it is used in the landscape display mode.

### SUMMARY OF INVENTION

The present invention enables realization of a technology, whereby images can be displayed at the same operability level in each display direction, i.e. in the portrait direction and in the landscape direction, without holding separate sets of display data corresponding to the display directions.

One aspect of the present invention provides a display apparatus displaying a screen, comprising: detection means for detecting an orientation of the display apparatus, and display control means for controlling a display unit to display, in a case where the detection means have detected that the orientation of the display apparatus is a first orientation, the first screen and the second screen side by side without overlapping based on first display data and second display data, and to display, in a case where the detection means have detected that the orientation of the display apparatus is a second orientation, the first screen and the second screen such that at least a portion thereof overlap based on the first display data and the second display data.

Another aspect of the present invention provides a method for controlling a display apparatus displaying a screen, comprising: detecting an orientation of the display apparatus; and controlling a display unit to display, in a case where it is detected in the detection step that the orientation of the display apparatus is a first orientation, display a second display screen are used to display the first screen and the second screen side by side without overlapping based on first display data and second display data, and to display, in a case where it is detected in the detection step that the orientation of the display apparatus is a second orientation, the first screen and the second screen such that at least a portion thereof overlap based on the first display data and the second display data.

Still another aspect of the present invention provides a computer-readable storage medium storing a computer program used to execute, on a computer, a method for controlling a display apparatus displaying a screen, the program comprising: detecting an orientation of the display apparatus; and controlling to display, in a case where it is detected in the detection step that the orientation of the display apparatus is a first orientation, a second display screen are used to display the first screen and the second screen side by side without overlapping based on first display data and second display data, and to display, in a case where it is detected in the detection step that the orientation of the display apparatus is a second orientation, the first screen and the second screen such that at least a portion thereof overlap based on first display data and second display data.

Further features of the present invention will be apparent from the following description of exemplary embodiments with reference to the attached drawings.

### BRIEF DESCRIPTION OF DRAWINGS

FIG. 1 is a schematic view illustrating the environment of use of an image forming apparatus according to an embodiment of the present invention.

FIG. 2 is a block diagram depicting the configuration of the main body, home position, and operating panel.

FIG. 3 is a flowchart depicting the display processing performed by the operating panel of Embodiment 1.

FIGS. 4A and 4B are made up of FIG. 4A that shows an exemplary screen displayed when the facsimile transmission feature is selected, and FIG. 4B, which shows an exemplary display of the address book used during facsimile transmission.

FIG. 5 is a diagram showing an exemplary basic screen of the operation unit.

FIG. 6 is a flowchart depicting the input display processing of S9 in FIG. 3.

FIGS. 7A-7D are diagrams depicting the relationship between the display direction of the operating panel and the origins of the respective display data of the shared and non-shared screens.

FIGS. 8A and 8B are diagrams showing exemplary displays of a facsimile screen, with A showing an exemplary display of a facsimile mode screen and a key operation unit, and B showing an exemplary display of a facsimile mode screen and an address book.

FIGS. 9A and 9B are diagrams showing exemplary displays of a facsimile mode screen oriented in the portrait display direction.

FIGS. 10A and 10B are diagrams showing exemplary displays of a facsimile mode screen oriented in the landscape display direction along with a key operation unit, as well as a facsimile mode screen along with an address book.

FIGS. 11A and 11B are diagrams showing exemplary displays of facsimile mode screens oriented in the landscape display direction.

FIGS. 12A and 12B are diagrams showing exemplary screen displays according to Embodiment 2.

FIGS. 13A-13D are diagrams depicting exemplary displays of the portrait-mode display data used in Embodiment 2.

FIG. 14 is a block diagram illustrating the configuration of the home position and operating panel according to Embodiment 3.

FIG. 15 is a flowchart depicting the process of detection of the display direction of an operating panel utilizing a tilt sensor and a three-dimensional acceleration sensor.

FIG. 16 is a block diagram illustrating the configuration of a home position and operating panel according to another example of Embodiment 3.

### DESCRIPTION OF EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Although the present embodiment uses an image forming apparatus (image processing apparatus) as an example, the present invention is not limited thereto.

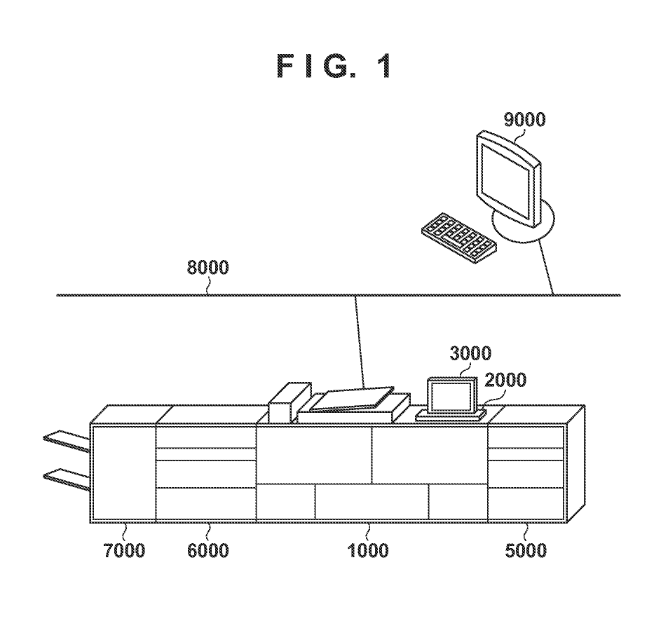

FIG. 1 is a schematic view illustrating the environment of use of an image forming apparatus according to an embodiment of the present invention.

The image forming apparatus (image processing apparatus) of the present embodiment is an apparatus generally known as a print-on-demand (POD) system, which responds to requests for colored printing and bookbinding by combining various options that enable saddle-stitched binding, trimming, folding, etc.

The image forming apparatus (image processing apparatus) of FIG. 1 shows an example, in which a paper media deck 5000, a binder 6000, and a finisher 7000 are combined with an image forming apparatus main body (hereinafter referred to as the main body) 1000. The main body 1000 is connected to a personal computer 9000 through a LAN 8000. In this personal computer 9000, the creation and editing of pages containing images or document data results in the generation of print jobs composed of settings for binding, trimming, folding, etc. The thus generated print jobs are sent to the main body 1000 through the LAN 8000.

In addition, in FIG. 1, a detachable operating panel (image display apparatus) 3000, which is characteristic of the present embodiment, is installed in a home position 2000 mounted to the main body 1000. When installed in the home position 2000, this detachable operating panel 3000 is adapted to charge a built-in electric battery by consuming electrical power supplied from the home position 2000. Furthermore, since the paper media deck 5000, binder 6000, and finisher 7000, etc. are not directly pertinent to the present invention, their detailed descriptions are omitted.

### Embodiment 1

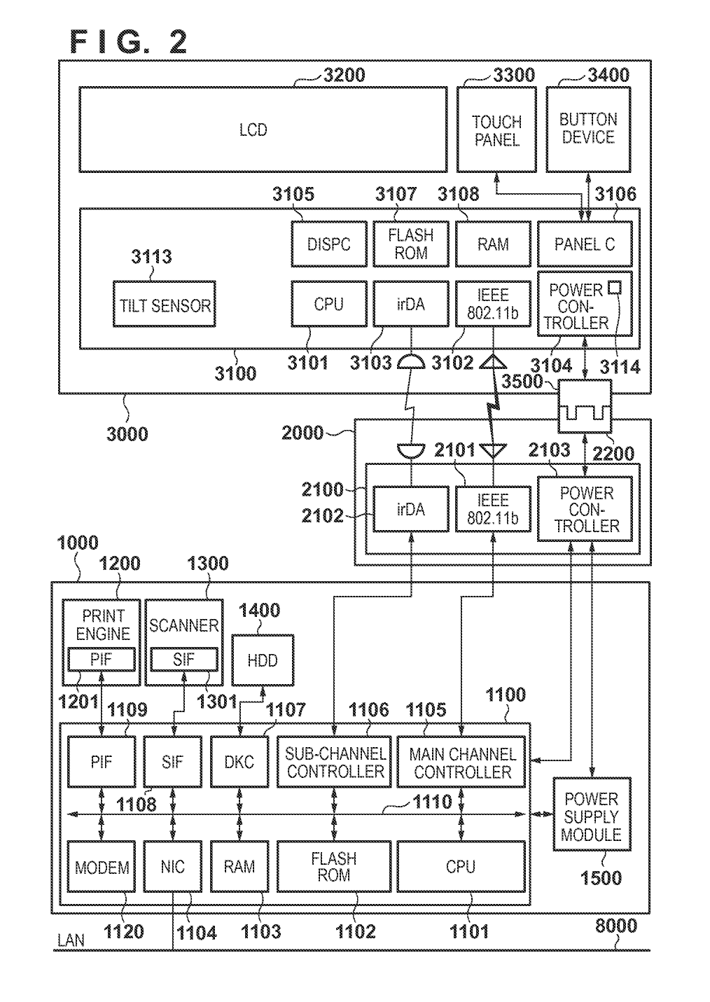

FIG. 2 is a block diagram depicting the configuration of the main body 1000, home position 2000, and operating panel 3000 according to Embodiment 1. The modules respectively constituting the main body 1000, home position 2000, and operating panel 3000 are described below. The main body 1000 is described first.

As shown in FIG. 2, the main body 1000 has a controller board 1100, a print engine 1200, a scanner 1300, a hard disk drive (HDD) 1400, and a power supply module 1500. These units operate by consuming electrical power supplied by the power supply module 1500.

The controller board 1100 has a CPU 1101, a flash ROM 1102, a RAM 1103, a network interface card (NIC) 1104, a main channel controller 1105, and a sub-channel controller 1106. Furthermore, it is equipped with a disk controller (DKC) 1107, a scanner interface (SIF) 1108, and a printer interface (PIF) 1109. Each one of these devices 1101-1109 is connected to the CPU 1101 through a bus 1110.

The CPU 1101 is a processor that runs control programs stored in the flash ROM 1102 and HDD 1400 and exercises overall control over the devices connected to the bus 1110. The RAM 1103 is used as a work area and a main memory for the CPU 1101. In addition, the RAM 1103 operates as a display memory used to store display data displayed on a display unit 3200. The NIC 1104 performs bidirectional data interchange between the personal computer 9000 and other image forming devices via the LAN 8000. The HDD 1400 is accessed through the DKC 1107 and is used not only for storing control programs, but also as a temporary storage location for images.

The scanner 1300 is equipped with a readout sensor, an original-conveying mechanism, etc. (none shown). The readout sensor and the original-conveying mechanism, etc., are controlled based on software run by the CPU 1101 via the SIF 1108 installed in the controller board 1100 and SIF 1301 installed in the scanner 1300. As a result, an original is read out by the readout sensor and the obtained data is transferred through the SIF 1301 and SIF 1108 to the controller board 1100.

In addition, the print engine 1200 is equipped with an electrophotographic recording unit, a recording paper cassette, a paper media-conveying unit, etc. (none shown). Print requests based on print jobs are sent from the controller board 1100 through the PIF 1109 and PIF 1201, which is installed in the print engine 1200. The recording unit and paper media-conveying unit, etc. are controlled in the same manner through the PIF 1109 and PIF 1201 based on software programs run by the CPU 1101. As a result, images corresponding to the print requests are formed on the paper media.

The main channel controller 1105 and sub-channel controller 1106 are used for interchanges between the main body 1000 and detachable operating panel 3000. This will be discussed in detail below.

The home position 2000 is described next.

As shown in FIG. 2, the home position 2000 is mainly equipped with a main board 2100 and a connector 2200. The main board 2100 is mainly equipped with an IEEE 802.11b module 2101, an irDA module 2102, and a power controller 2103. The IEEE802.11b module 2101 is connected to the main channel controller 1105 of the controller board 1100 and mediates wireless communication with the operating panel 3000 based on requests from the controller board 1100. The irDA module 2102 is connected to the sub-channel controller 1106 of the controller board 1100 and mediates wireless communication with the operating panel 3000 based on requests from the controller board 1100. The power controller 2103 is connected to the power supply module 1500. The IEEE802.11b module 2101 and irDA module 2102 receive electrical power supply via the power controller 2103. In addition, the power controller 2103 is also connected to the connector 2200 and supplies electrical power to the operating panel 3000 when the connector 3500 of the operating panel 3000 is in a contact position. Additionally, the power controller 2103 monitors the power status, detects whether or not the operating panel 3000 has been installed in the home position 2000, and transmits the detection results to the controller board 1100. In addition, the power controller 2103 is also connected to the connector 2200 and supplies electrical power to the operating panel 3000 when the connector 3500 of the operating panel 3000 is in a contact position. Additionally, the power controller 2103 monitors the power status, detects whether or not the operating panel 3000 is installed in the home position 2000, and transmits the result to the controller board 1100. Furthermore, when detection means used for determining the presence of an installed panel recognizes that the operating panel 3000 has been installed in the main body, the operational direction of the operating panel 3000 is decided to be the landscape direction without relying on the sensors 3111˜3113 described below.

The operating panel 3000 is described next.

The detachable operating panel 3000 is mainly furnished with a main board 3100, a display unit (LCD) 3200, a touch panel 3300, a button device 3400, and a connector 3500. The main board 3100 has a CPU 3101, an IEEE 802.11b module 3102, an irDA module 3103, and a power controller 3104. In addition, it has a display controller (DISPC) 3105, a panel controller (PANELC) 3106, a flash ROM 3107, and a RAM 3108. The respective modules 3101˜3108, in the same manner as the controller board 1100, are connected with the help of a bus (not shown).

The CPU 3101 is a processor that runs control programs stored in the flash ROM 3107 along with exercising overall control over the devices connected to the bus. The RAM 3108 operates as a main memory for the CPU 3101, as a work area, and as a storage area for video data displayed on the LCD 3200. A tilt sensor 3113 is provided in order to detect the operational direction (display direction) of the operating panel 3000. As used herein, the tilt sensor 3113 is a sensor that detects whether the operating panel 3000 is oriented in the landscape direction (when the display unit 3200 is in the landscape display mode) or in the portrait direction (when the display unit 3200 is in the portrait display mode).

The display controller (DISPC) 3105 exercises control over the LCD 3200 along with transferring video images rendered in the RAM 3108 to the LCD 3200 in accordance with requests from the CPU 3101. As a result, the images are displayed on the LCD 3200. The panel controller (PANELC) 3106 controls the touch panel 3300 and button device 3400 in accordance with requests from the CPU 3101. Such control allows for press positions on the touch panel 3300, as well as key codes pressed on the button device 3400, to be sent back to the CPU 3101. The power controller 3104 is connected to the connector 3500 and receives electrical power supply from the power supply module 1500 of the main body 1000 when the connector 2200 of the home position 2000 is in a contact position. As a result, electrical power is supplied to the entire operating panel 3000 while charging a rechargeable battery 3114 connected to the power controller 3104. Electrical power from the rechargeable battery 3114 is supplied to the entire operating panel 3000 when no electrical power is supplied from the power supply module 1500.

As a result of control exercised by the CPU 3101, the IEEE802.11b module 3102 establishes wireless communication with the IEEE802.11b module 2101 in the home position 2000 and mediates communication with the main body 1000. As a result of control exercised by the CPU 3101, the irDA module 3103 establishes infrared communication with the irDA module 2102 in the home position 2000 and mediates communication with the main body 1000.

Wireless communication used as the main channel in Embodiment 1 is described next.

As alluded to in connection with FIG. 2, in Embodiment 1, wireless communication used as the main channel conforms to the IEEE802.11b Specification, which is a publicly-known technology. More particularly, in the system of Embodiment 1, wireless communication is carried out in an infrastructure mode, in which the main body 1000 is used as an access point (AP) and the operating panel 3000 constitutes a terminal. In the same manner as in existing personal computers, when there are multiple main bodies within the radio wave range, a configuration is used, in which the ESSIDs of the multiple communication-enabled main bodies can be displayed and one of them can be selected on the operating panel 3000.

After establishing the communicating party by means of association, the operating panel 3000 operates as a thin client effecting display on the display unit 3200 and detection of input produced by the operator using the touch panel 3300 and button device 3400 for the purpose of controlling the operation of the main body. Thus, the bulk of operations such as recording signal generation processing and status management of the main body of the apparatus is carried out by the CPU 1101 of the main body 1000. The status of the main body of the apparatus is wirelessly sent from the main body 1000 to the operating panel 3000 in accordance with a predetermined protocol.

On the other hand, the CPU 3101 of the operating panel 3000 exercises display control over the display unit 3200 in accordance with information on user operations performed on the touch panel 3300 of the operating panel 3000 and on the button device 3400. Instructions on the initiation etc. of the main body under conditions configured by the operator are wirelessly sent to the main body 1000 along with requesting required information on the main body of the apparatus corresponding to the operations of the operator from the main body 1000. Consequently the CPU 1101 of the main body 1000 exercises control over each individual operation on the basis of the passed information. As described above, the system according to the present embodiment is a system that allows for communication between the main body 1000 and the operating panel 3000.

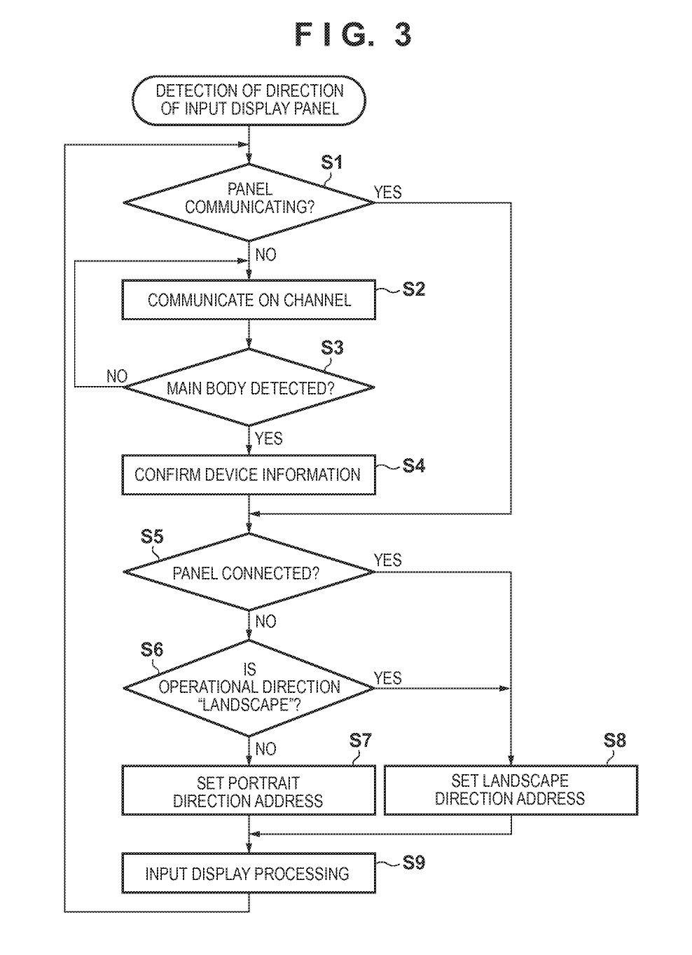

FIG. 3 is a flowchart depicting the display processing performed by the operating panel 3000 of Embodiment 1. It should be noted that the software program that executes the processing operations shown in this flowchart is stored in the flash ROM 3107 and is executed under the control of the CPU 3101.

First of all, in S1, the CPU 3101 of the operating panel 3000 determines the wireless communication state of the main channel (carries out communication state determination processing) and determines whether or not communication with the main body 1000 is in progress. If it is determined in S1 that no communication based on wireless communication on the main channel is in progress, the program advances to S2 and a request to establish main-channel communication with the main body 1000 is transmitted to the main body 1000. It should be noted that when there are multiple main bodies within the radio wave range of the main channel, the ESSIDs of the multiple communication-enabled main bodies are displayed on the operating panel 3000, the user can select one of them, and a request is sent to the main body with the selected ESSID. The program then advances to S3 and the CPU 3101 determines whether or not the main body 1000 has been detected depending on whether a response is received to the effect that communication to/from the main body 1000 is authorized, and the processing of S2 and S3 is repeated until detection of the main body 1000.

In this manner, when it is determined in S3 that the main body 1000 has been detected, the CPU 3101 establishes main-channel communication with the main body 1000 and advances processing to S4. In S4, the CPU 3101 verifies the device ID, enabled features, and other device information of the main body 1000. Specifically, the CPU 3101 transmits a verification request (a request to verify the device ID, enabled features, and other device information of the main body 1000) to the main body 1000 and advances processing to S5 upon receipt of the device information from the main body 1000. On the other hand, if it is determined in S1 that communication with the main body 1000 is in progress based on wireless communication on the main channel, the CPU 3101 advances processing to S5 without intermediate steps.

In S5, the CPU 3101 determines whether or not the operating panel 3000 has been placed in the home position 2000 of the main body 1000 and whether or not the operating panel 3000 and main body 1000 are connected. Then, if it is determined that the operating panel 3000 and main body 1000 are connected, the CPU 3101 branches to S8 and performs panel display processing only in the landscape direction. On the other hand, if it is determined in S5 that there is no communication between the operating panel 3000 and main body 1000, the CPU 3101 advances processing to S6. It should be noted that in S6 the operator detaches the operating panel 3000 from the main body 1000 and decides whether or not its operational direction is the landscape direction based on the output of the tilt sensor 3113. If based on the output of the tilt sensor 3113 it is determined that it is the landscape direction, the program advances to S8, carries out input display processing in the landscape direction, and after that advances to shared input display processing (S9). On the other hand, if based on the output of the tilt sensor 3113 it is determined that it is the portrait direction, the program advances to S7, carries out input display processing in the portrait direction, and advances to shared input display processing (S9). The processing of steps S1 to S9 is repeated as long as there is power supplied to the operating panel 3000.

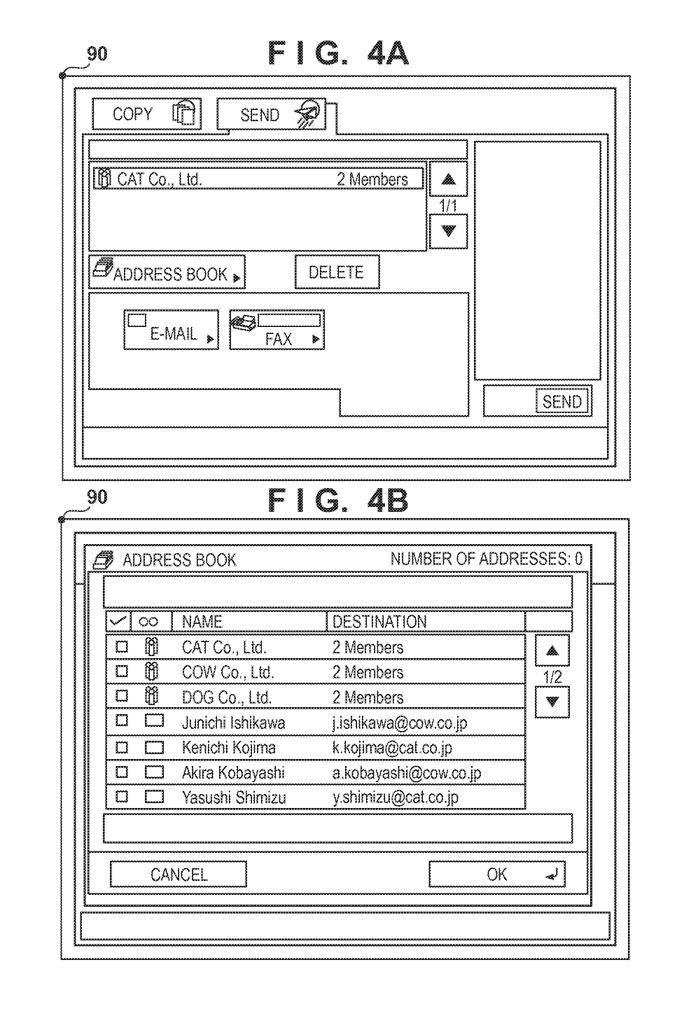

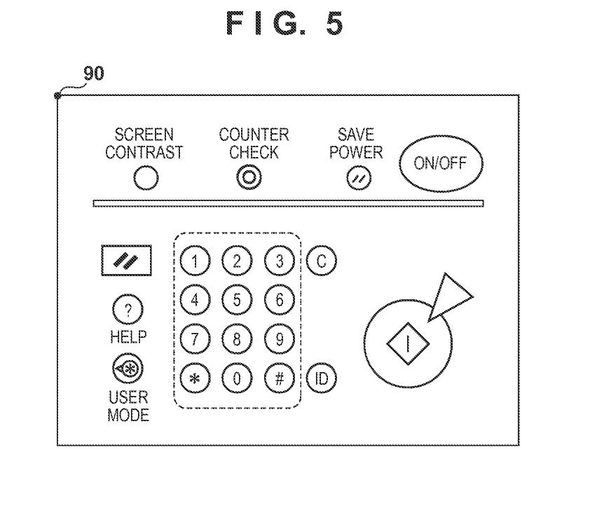

FIGS. 4A-5 are diagrams illustrating exemplary contents heretofore displayed on the operational panel.

FIG. 4A is a diagram showing an exemplary screen displayed on the display unit 3200 when the facsimile transmission feature is selected on the basic mode screen (not shown). The display data is stored in the flash ROM 3107 and is normally displayed after rendering (768×512) pixels from the origin 90 in the RAM 3108.

FIG. 4B is a diagram showing an exemplary display of the address book used during facsimile transmission. The display data is stored in the flash ROM 3107. The display data is also stored in the flash ROM 3107 and is displayed after rendering (768×512) pixels from the origin 90 in the RAM 3108.

FIG. 5 is a basic screen used as an operation unit, on which a 10-key keypad, a Start key, a Stop key, and the like are displayed. It operates in the same manner as a regular key operation unit, with the corresponding key information entered in accordance with the keystrokes of the user. This image is also displayed after rendering (768×512) pixels from the origin 90 in the RAM 3108.

Here, the screens shown in FIGS. 4A and 4B are diagrams illustrating exemplary display screens conventionally displayed on the display unit of the main body 1000, which is approximately 8 inches in size. In addition, the screen shown in FIG. 5 represents the key operation unit attached to the main body 1000 displayed on the touch panel 3300.

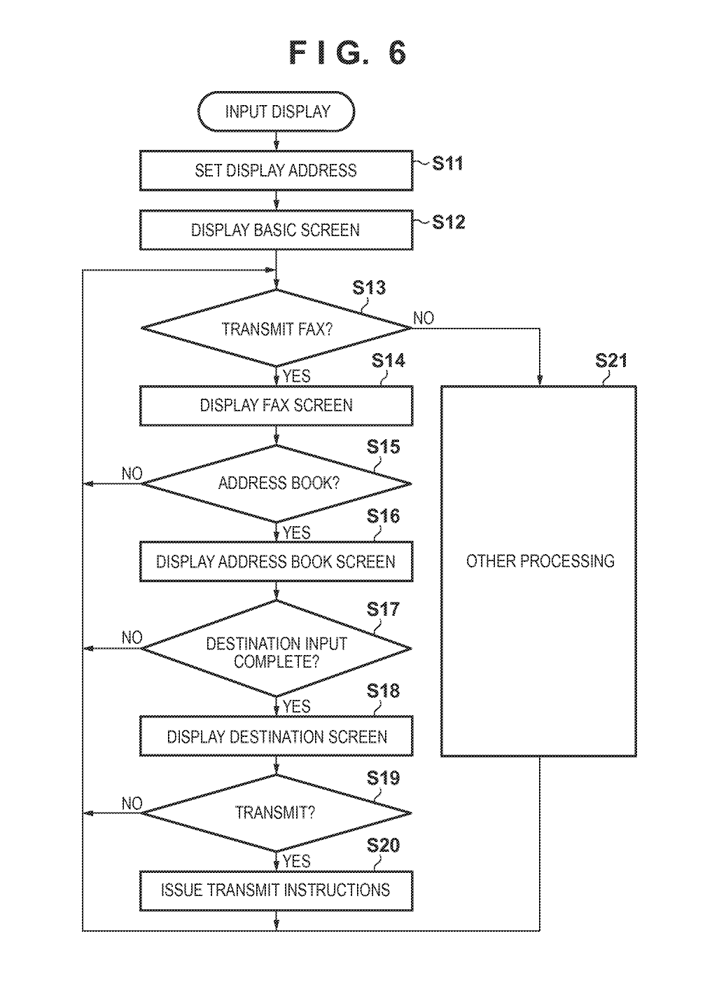

Next, the processing of S9 in the flowchart of FIG. 3 is described in detail with reference to FIG. 6. In the same manner as the processing operations illustrated in the flowchart of FIG. 3, the software program that executes the processing operations shown in the flowchart of FIG. 6 is stored in the flash ROM 3107 and is executed under the control of the CPU 3101.

FIG. 6 is a flowchart depicting the input display processing of S9 in FIG. 3.

First of all, the address of the origin of the display data corresponding to the display direction of the operating panel 3000 is read in S11.

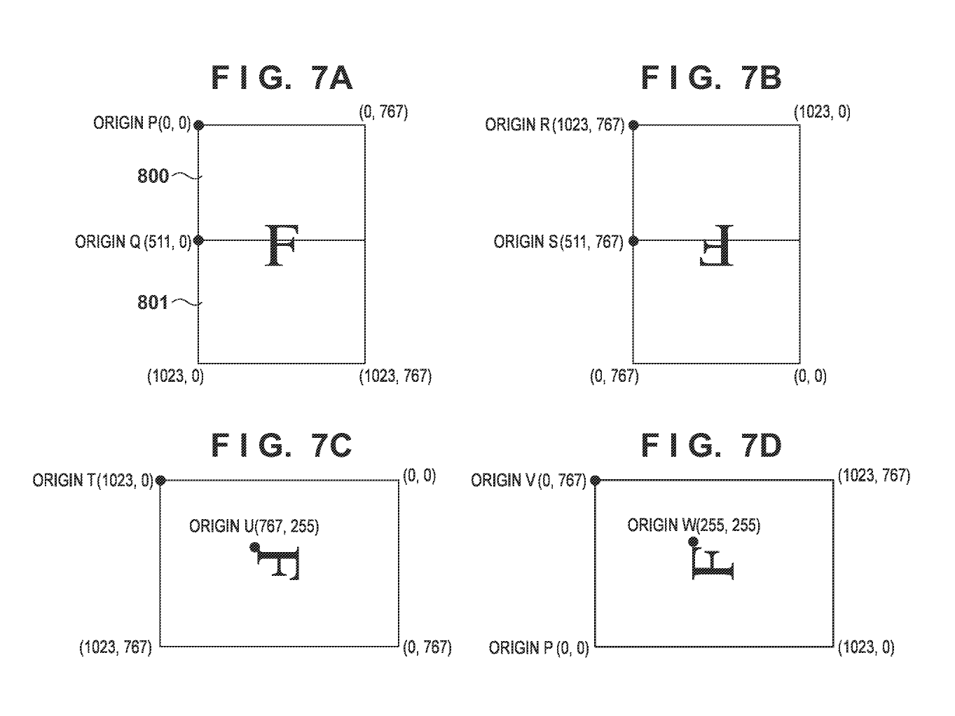

FIGS. 7A-7D are diagrams depicting the relationship between the display direction of the operating panel and the origins of the respective display data of the shared and non-shared screens. FIGS. 7A and 7B illustrate cases with a portrait display direction, and FIGS. 7C and 7D cases with a landscape display direction. It should be noted that the size of the display area of the display unit 3200 used in the present embodiment is a rectangle of (1024×768) pixels. Accordingly, in the case of a portrait display direction, two different sets of display data using (512×768) pixels from each origin as a unit can be displayed without overlapping.

FIG. 7A shows a case, in which the display direction of the operating panel 3000 is the portrait direction, with the address of the origin P of the shared screen 800 set to (0,0) and the address of the origin Q of the non-shared screen 801 set to (511,0). The two respective sets of display data displayed on each one of these screens are stored in the flash ROM 3107. The display data read out from the flash ROM 3107 is rendered using (768×512) pixels diagonally from the addresses corresponding to the origin P and origin Q of the RAM 3108. In such a case, address change processing is executed under the control of the CPU 3101. In this manner, a screen corresponding to the display direction of the operating panel 3000 is displayed on the display unit 3200.

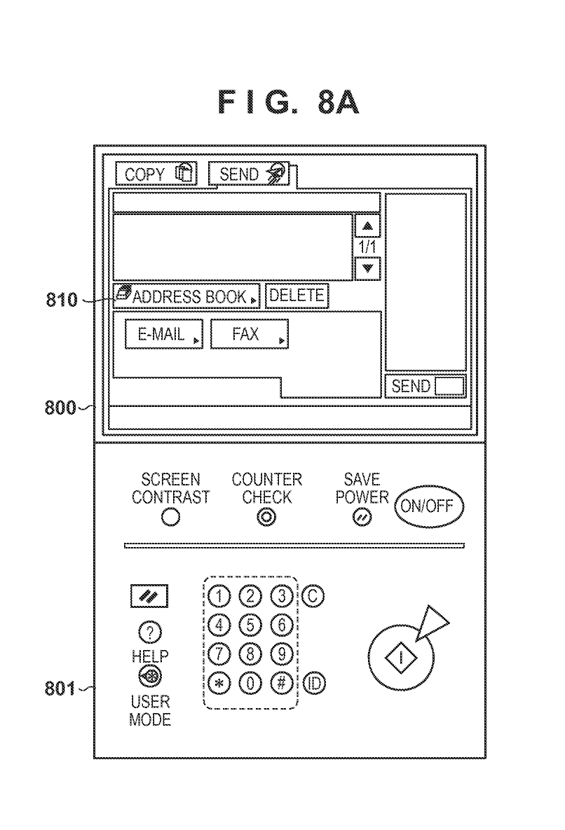

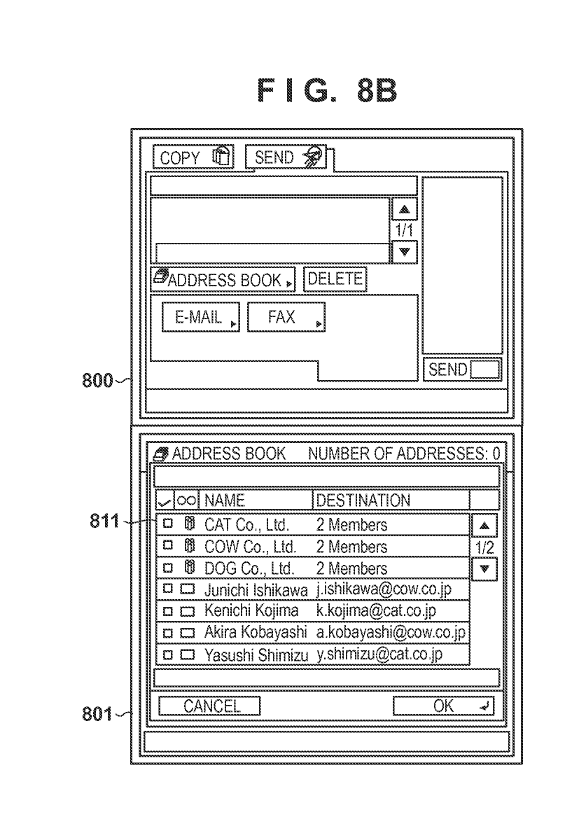

Next, the program advances to S12 and displays a basic screen (not shown) in accordance with the display direction of the operating panel 3000. Then, in S13, when the operator selects facsimile transmission, the program branches to S14 and switches the display from the basic screen to the facsimile screen illustrated in FIG. 8A. It should be noted that if a setup operation other than the facsimile transmission is performed in S13, the program branches to S21 and executes the specified processing. Here, however, its description is omitted.

FIG. 8A is a diagram showing an exemplary display of a Facsimile Screen.

In FIG. 8A, the facsimile mode screen illustrated in FIG. 4A is displayed on the shared screen 800 after rendering from origin P. In addition, the basic operational setup screen illustrated in FIG. 5 is displayed on the non-shared screen 801 after rendering from origin Q.

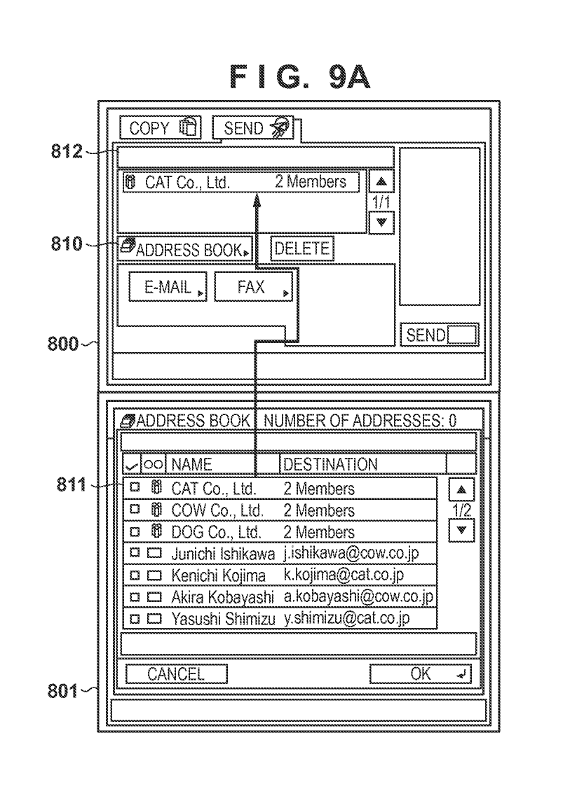

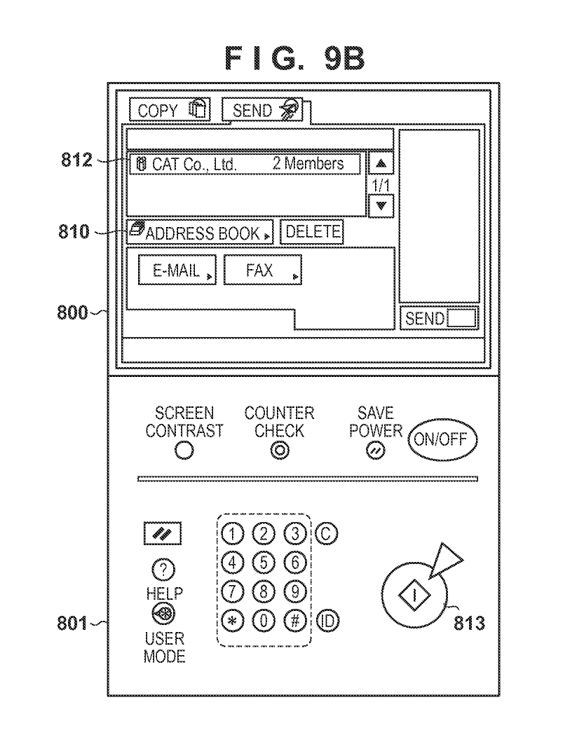

FIG. 8B illustrates an exemplary screen displayed on the display unit 3200 when the Address Book key 810 of the facsimile mode screen of FIG. 8A is pressed. It is displayed when the depression of the Address Book key 810 is detected in S15 of FIG. 6, the program advances to S16, and a screen display of the address book is carried out. In FIG. 8B, the destination display data shown in FIG. 4B is rendered from origin Q in the RAM 3108. A state obtained by selecting destination 811 on the address book screen illustrated in FIG. 8B and dragging it to the destination field 812 of the facsimile mode screen is illustrated in FIG. 9A. This operation corresponds to the processing of S17˜S18 of FIG. 6. The screen shown in FIG. 9B is then displayed in S19.

FIG. 9B shows a state obtained by rendering the operational setup screen of FIG. 5 from origin Q in the RAM 3108 and displaying it on the non-shared screen 801. When the Start key 813 of this operational setup screen is pressed, the program advances from S19 to S20 of FIG. 6, and the CPU 3101 communicates an instruction to effect facsimile transmission to the main body 1000 along with the configured destination data. Upon receipt of the instruction to effect facsimile transmission, the CPU 1101 of the main body 1000 reads the original using the scanner 1300 and transmits the image of the original that has been read as data to an external location through the modem 1120.

It should be noted that, in FIG. 9B, the simultaneous display of the operation mode screen of FIG. 4A and the operational setup screen of FIG. 5 on the display unit 3200 makes it easier to issue instructions to start and stop a facsimile transmission.

In addition, when the portrait display direction shown in FIG. 7B is detected by the tilt sensor 3113, the respective origins of the display data are the origin R (1023,767) and the origin S (511,767). In this case, screen transitions are effected in accordance with the FIGS. 8A and 8B and FIGS. 9A and 9B as explained above. In this case, the display contents are identical, but the display direction illustrated in FIG. 7B is obtained by rotating the operating panel 3000 through 180 degrees from the display direction illustrated in FIG. 7A. Consequently, as a result of rendering the display data stored in the flash ROM 3107 relative to the respective origins in the RAM 3108, the appearance of the screen display follows the 180-degree rotation of the operating panel 3000.

A case, wherein the landscape display direction shown in FIG. 7C is detected by the tilt sensor 3113, is described next.

When the display direction is as shown in FIG. 7C, the facsimile mode screen of FIG. 4A described above is rendered from origin T (1023,0) in the direction of a diagonally opposite point (0,767). In addition, the operational setup screen of FIG. 5 is displayed by rendering the display data in the RAM 3108 from origin U (767,255) in the direction of a diagonally opposite point (0,767). This example is illustrated in FIG. 10A. In addition, the display direction illustrated in FIG. 7D is obtained by rotating the operating panel 3000 through 180 degrees from the display direction illustrated in FIG. 7C. Consequently, as a result of rendering the display data stored in the flash ROM 3107 relative to the respective origins in the RAM 3108, the appearance of the screen display follows the 180-degree rotation of the operating panel 3000.

The Facsimile Screen displayed in S14 of FIG. 6 is as shown in FIG. 10A. Here, the display data used to display the screens of the key operation unit of FIG. 5 and FIG. 4A is displayed in the landscape direction, as a result of which the two sets of display data cannot be displayed side by side on a single screen, and, consequently, there is some overlapping in the central portion of the screen. However, since the display data stored in the flash ROM 3107 can be used both in the portrait and landscape display directions, its volume can be halved in comparison with storing data separately for dedicated use, which can make the system less expensive. In particular, the effects of sharing display data as described in the present embodiment become more pronounced due to the enormous number of display screens used in devices with multiple features and numerous settings, such as multi-functional printers. When the partially hidden screen among the two screens displayed in FIG. 10A is touched by the user, the CPU 3101 exercises control such that the touched screen is displayed in front of the other screen. As a result, the user can readily operate the screen displayed in front. In the exemplary display discussed below, touching the partially hidden screen results in the touched screen being displayed in front of the other screen.

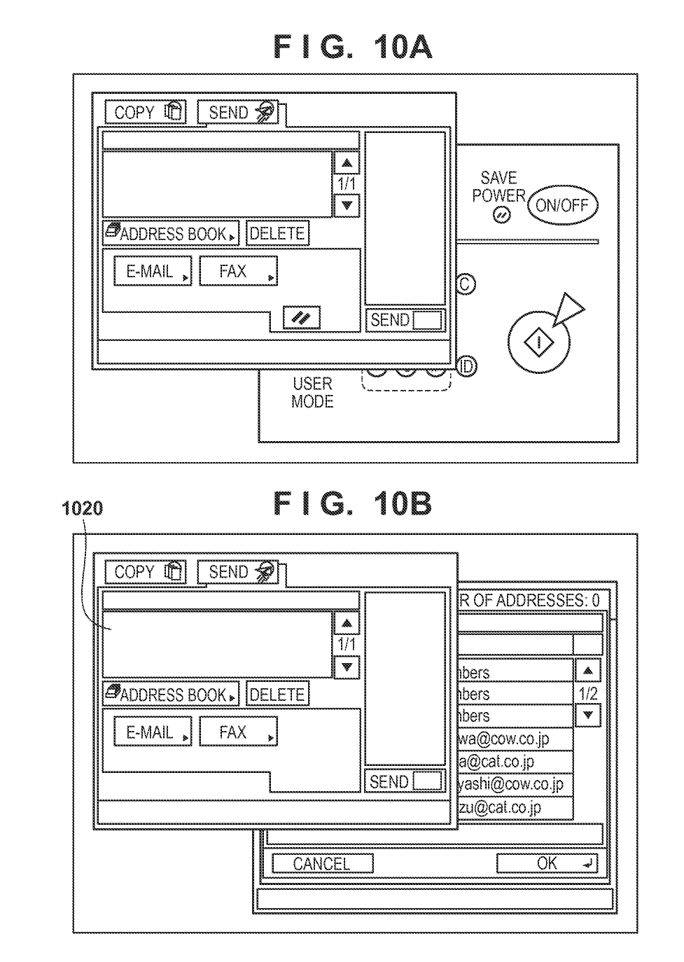

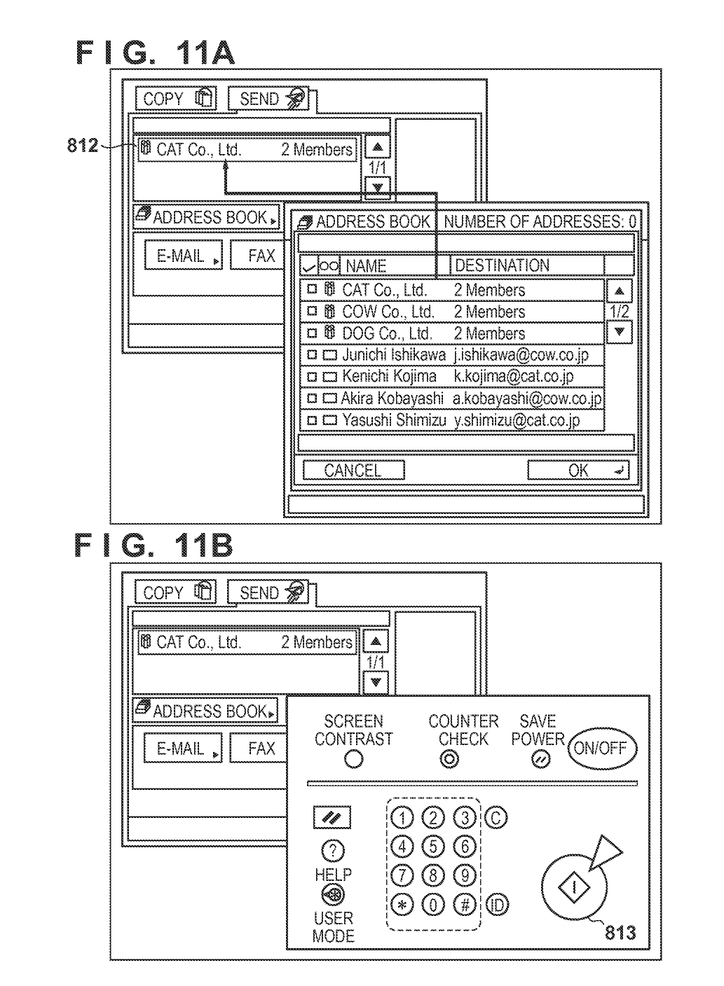

As shown in FIG. 10B, the address book displayed in S16 of FIG. 6 is displayed such that it overlaps with the facsimile mode screen. In this case, as shown in FIG. 11A, the transmission destination of the facsimile data can also be configured by receiving the user's action of dragging the desired destination from the address book with a finger and entering it in the destination input field 812. It should be noted that since the address book is displayed in front (FIG. 11A) if the address book is touched in the state of FIG. 10B, the user can simply drag the desired destination with a finger to the destination input field 812 when the address book is displayed in front. In addition, as described above, data transmission is carried out via a modem 1120 under the control of the CPU 1101 of the main body 1000. Specifically, after configuring the destination and pushing the Start key, the CPU 1101 transmits the data depicting the image of the original read by the scanner 1300 to the configured destination through the modem 1120. It should be noted that the data may be transmitted not only through the facsimile, but also through the LAN 8000. In such a case, the CPU 3101 detects the dragging of the e-mail address from the address book to the input field 812 and transmits the data depicting the image of the original read by the scanner 1300 by e-mail to the dragged e-mail address.

In addition, when the screen illustrated in FIG. 11B is displayed in S18 of FIG. 6 and the Start key 813 is pressed on the operational setup screen, the CPU 3101 communicates an instruction to effect facsimile transmission to the main body 1000 along with the configured destination data.

In FIG. 11B, the simultaneous display of the operation mode screen of FIG. 4A and the operational setup screen of FIG. 5 makes it possible to easily issue instructions to start and stop the facsimile transmission.

It should be noted that after pushing the Start key 813, the CPU 3101 may exercise control such that the operational setup screen of FIG. 5 is always displayed in front of the other screen during the data transmission operation. This helps the user find the key used to stop the data transmission and easily issue instructions to stop the transmission of data.

As explained above, according to Embodiment 1, a display corresponding to the display direction of the operating panel can be implemented using shared display data. As a result, regardless of the display direction in which the operating panel is used, the displayed images and the position of the input keys in the display area remain identical, thereby preserving the level of operability.

### Embodiment 2

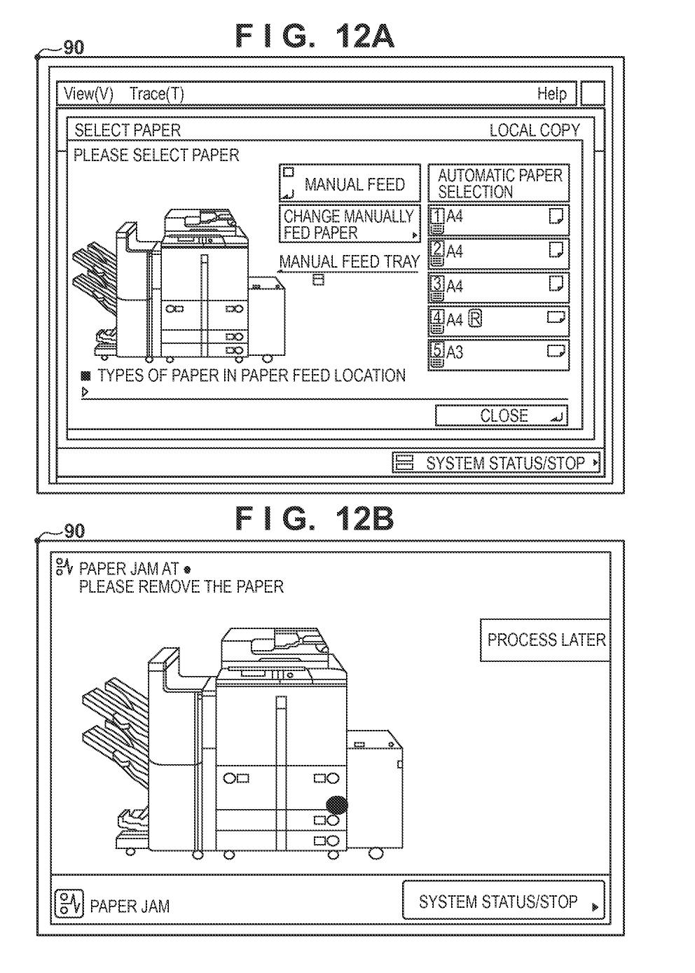

FIGS. 12A and 12B are diagrams showing exemplary screen displays according to Embodiment 2. In addition, since the configuration of the main body of the image forming apparatus and the operating panel, etc. used in Embodiment 2 is the same as in Embodiment 1, their descriptions are omitted.

FIG. 12A shows a setup screen used when selecting the Copy Mode key on the basic mode screen and, after that, selecting a paper feed tray. This exemplary display shows a pictorial image illustrating the actual apparatus. If this pictorial image is rotated in accordance with the display direction of the operating panel 3000 and its aspect ratio is made to conform to a size that matches the display direction, it will stop resembling the actual apparatus. For this reason, Embodiment 2 attempts to display the same image regardless of the display direction of the operating panel 3000.

FIG. 12B shows an exemplary display corresponding to a screen displayed when recording paper causes a paper jam during copying, etc. In the same manner as in FIG. 12A, it is impossible to display the image by changing the aspect ratio according to the display direction in order to show the actual location of the paper jam in this exemplary display. It should be noted that since the Start key and Stop key of Embodiment 1 displayed in FIG. 5 have a shape that has been already established in the industry, it is necessary to display the image without changing the aspect ratio.

Because these images of Embodiment 2 can be displayed using the same display data in both the portrait display direction and landscape display direction of the operating panel 3000, they can be displayed at the same aspect ratio and, in addition, the memory space used to store the display data can be reduced size.

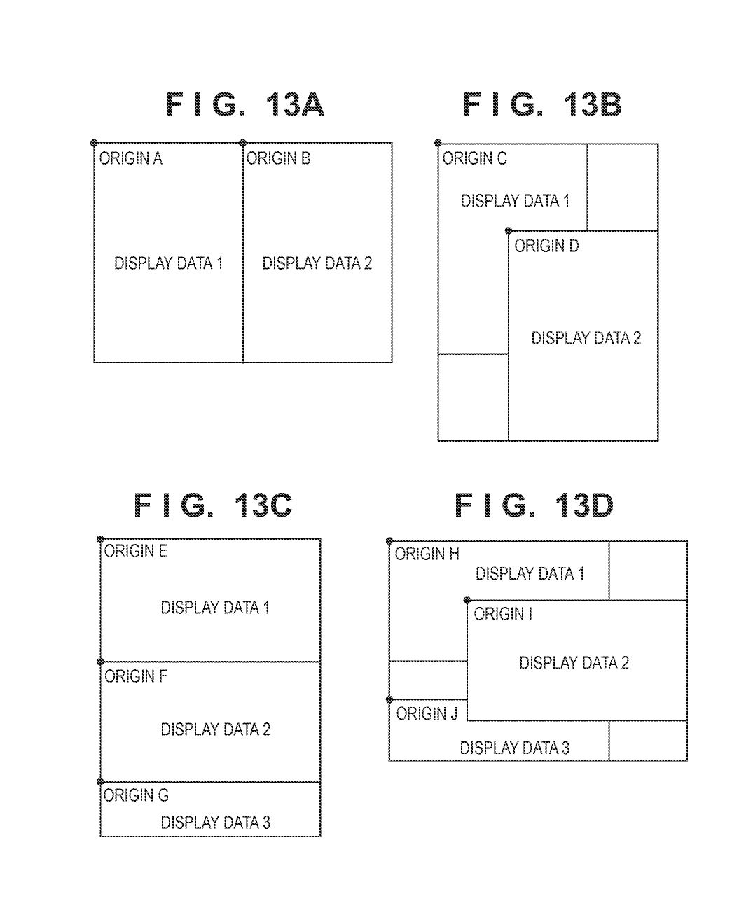

FIGS. 13A-13B are diagrams depicting exemplary displays of the portrait-mode display data used in Embodiment 2.

FIG. 13A shows a case, in which portrait-mode display data 1 and 2 are displayed by respectively rendering (512×768) pixels from origins A and B on the screen when it is oriented in a landscape display direction. Thus, when the display data is portrait-mode data, in the case of a landscape display direction, the size is set to (512×768) pixels so as to be able to display over the entire area on the display unit 3200.

Therefore, since it is impossible to display two sets of display data side by side on a single screen in the case of a portrait display direction, as shown in FIG. 13B, the portrait-mode display data 1 and 2 are rendered respectively from origin C and from origin D. In this case, the images of the two sets of display data are displayed such that they overlap in the vicinity of the origin D. In this case, it goes without saying that the invention can be practiced in the same manner as explained in connection with the above-described flowcharts of FIG. 3 and FIG. 6.

FIGS. 13C-13D are diagrams depicting exemplary displays of the landscape-mode display data used in Embodiment 2. FIG. 13C illustrates an example, in which three sets of landscape-mode display data 1, 2, 3 of mutually different sizes are displayed in the portrait display direction without overlapping. In this case, the sets of display data are displayed by rendering them respectively from origin E, origin F, and from origin G. FIG. 13D illustrates an example, in which the three sets of landscape-mode display data 1, 2, 3 of mutually different sizes illustrated in FIG. 13C are displayed in the landscape display direction. Because in this case the three sets of display data cannot be displayed side by side on a single screen, they are displayed by rendering display data 1 from origin H, rendering display data 2 from origin I, and rendering display data 3 from origin J. In this case, display data 1 and display data 2 overlap in the vicinity of origin I. In addition, display data 2 and display data 3 overlap in the lower portion of display data 2. While FIG. 13D shows an example, in which the overlapping of the three images is minimized, the invention is not limited to this type of arrangement.

Thus, in Embodiment 2, multiple sets of display data can be displayed on a single screen without changing the size of each set of display data or the aspect ratio. In addition, even in the case of display data that is displayed overlapped and invisible on the screen, touching this portion brings it to the front of the screen. This makes it possible to easily verify the contents displayed in the entire set of display data.

### Embodiment 3

In the above-described Embodiments 1 and 2, the direction, in which the operator operated the operating panel 3000 was detected using the tilt sensor 3113. In general, due to the fact that the tilt sensor 3113 utilizes gravity, when the operating panel 3000 is placed on a horizontal surface, it is impossible to distinguish between a portrait display direction and a landscape display direction with the help of the tilt sensor 3113.

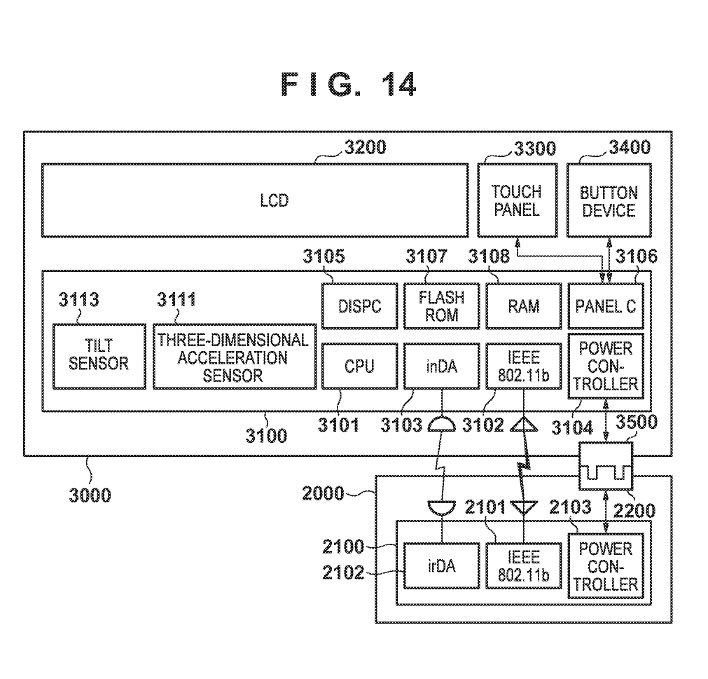

FIG. 14 is a block diagram illustrating the configuration of the home position 2000 and operating panel 3000 according to Embodiment 3. It shows the operating panel 3000, which has a three-dimensional acceleration sensor 3111 in addition to the tilt sensor 3113. In FIG. 14, the parts that are in common with the above-described FIG. 2 are designated using the same symbols, and their descriptions are omitted. In addition, since the configuration of the main body of the image forming apparatus and the operating panel, etc. used in Embodiment 3 is the same as in the above-described Embodiment 1 with the exception of what is shown in FIG. 14, their description is omitted.

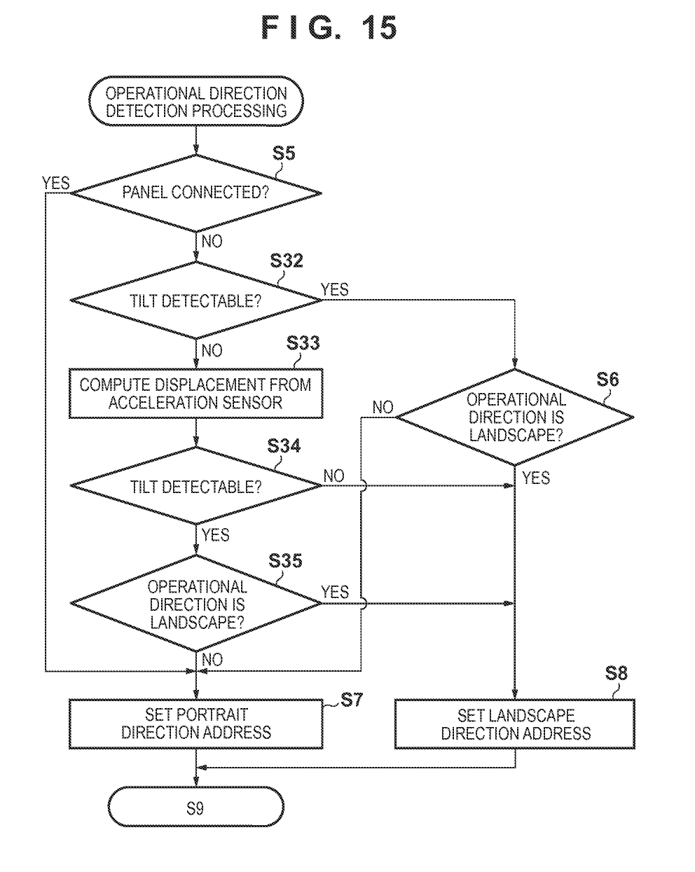

FIG. 15 is a flowchart depicting the process of detection of the display direction of an operating panel utilizing a tilt sensor 3113 and a three-dimensional acceleration sensor 3111. It should be noted that in FIG. 15, the steps that are in common with the above-described FIG. 3 are designated using the same symbols.

If the operating panel 3000 is in a horizontal state and the output of the tilt sensor 3113 is small and does not permit stable detection, the program advances from S32 to S33 and the direction is detected by processing the output of the acceleration sensor 3111. In S33, the output of the tilt sensor 3113 is used as an initial value and the output of the acceleration sensor 3111 is integrated twice to compute the distance of displacement from the initial value in each three-dimensional direction and determine the direction on the horizontal surface. It should be noted that in a horizontal state, when the operating panel 3000 is powered up or when the CPU 3101 is reset, as well as when the operating panel 3000 is not in motion, the initial position becomes uncertain even if the tilt sensor 3113 is used. Therefore, in S34, it is determined whether or not tilt detection can be performed using the tilt sensor 3113, and if it is determined that detection is impossible, it is decided that the direction is the landscape display direction, and the program advances to S8.

On the one hand, if in S34 the tilt can be detected based on the output of the acceleration sensor 3111, the program advances to S35 and makes a determination as to whether the direction is a portrait display direction or a landscape display direction. Then, the program advances to S7 (portrait display direction) or S8 (landscape display direction) depending on the results of the determination.

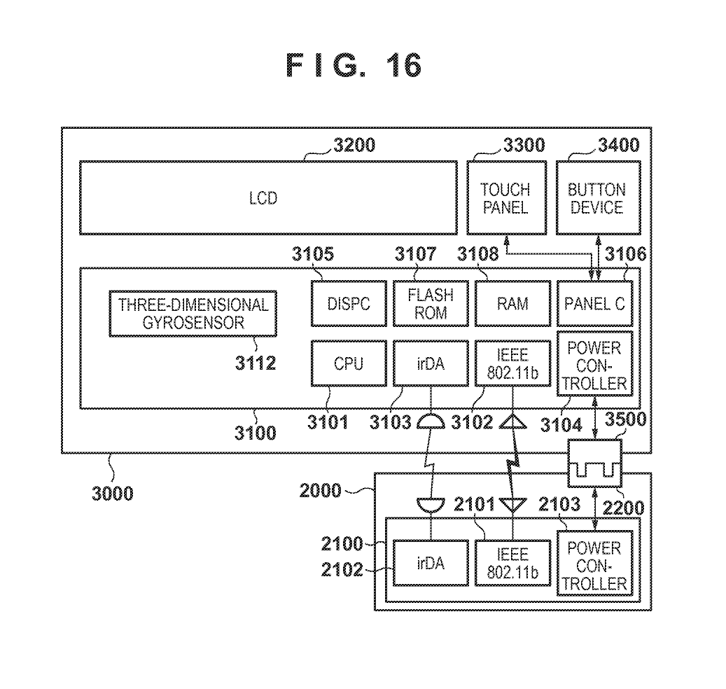

FIG. 16 is a block diagram illustrating the configuration of the home position 2000 and operating panel 3000 according to another example of Embodiment 3. It shows the operating panel 3000, which has a three-dimensional gyrosensor 3112 instead of the tilt sensor 3113. In FIG. 16, the parts that are in common with the above-described FIG. 2 are designated using the same symbols, and their descriptions are omitted.

The three-dimensional gyrosensor 3112 can mitigate the disadvantages of the above-described tilt sensor 3113 and three-dimensional acceleration sensor 3111. No matter what state the operating panel 3000 is in, its display direction can be detected in accordance with the flowchart described above with reference to FIG. 3.

As described above, in accordance with the present embodiment, an operator can use an operating panel capable of wireless communication with a main body either in the portrait display direction or in the landscape display direction. At such time, at least two sets of display data are adaptively laid out and displayed on a single screen in accordance with the display direction detected using at least two types of display data and display direction detection means. This makes it possible to display an operation screen that corresponds to the detected display direction and enables the user to perform instruction operations based on common operations in either display direction.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-267498 filed on Nov. 30, 2010 and 2011-247968 filed on Nov. 11, 2011 which are hereby incorporated by reference herein in their entirety.

1. A display apparatus displaying a screen, comprising:
detection means for detecting an orientation of the display apparatus, and
display control means for controlling a display unit to display,
in a case where the detection means have detected that the orientation of the display apparatus is a first orientation, the first screen and the second screen side by side without overlapping based on first display data and second display data, and
to display, in a case where the detection means have detected that the orientation of the display apparatus is a second orientation, the first screen and the second screen such that at least a portion thereof overlap based on the first display data and the second display data.

2. The display apparatus according to claim 1, wherein the first screen includes a screen used to receive settings used for transmitting data and the second screen includes a screen used to display the destination of transmission of the data.

3. The display apparatus according to claim 2, wherein the destination of transmission of the data is set by receiving an operation of dragging the destination of transmission of the data displayed on the second screen to the first screen.

4. The display apparatus according to claim 1, wherein the first screen includes a screen used to receive settings used for transmitting data and the second screen includes a screen used to stop the transmission of the data.

5. The display apparatus according to claim 4, wherein the display control means controls such that, while the data is transmitted, the screen used to stop the transmission of the data is continuously displayed in front of the screen used to receive settings used for transmitting the data.

6. A method for controlling a display apparatus displaying a screen, comprising:
detecting an orientation of the display apparatus; and
controlling a display unit to display, in a case where it is detected in the detection step that the orientation of the display apparatus is a first orientation, display a second display screen are used to display the first screen and the second screen side by side without overlapping based on first display data and second display data, and
to display, in a case where it is detected in the detection step that the orientation of the display apparatus is a second orientation, the first screen and the second screen such that at least a portion thereof overlap based on the first display data and the second display data.

7. A computer-readable storage medium storing a computer program used to execute, on a computer, a method for controlling a display apparatus displaying a screen, the program comprising:
detecting an orientation of the display apparatus; and
controlling to display,
in a case where it is detected in the detection step that the orientation of the display apparatus is a first orientation, a second display screen are used to display the first screen and the second screen side by side without overlapping based on first display data and second display data, and
to display, in a case where it is detected in the detection step that the orientation of the display apparatus is a second orientation, the first screen and the second screen such that at least a portion thereof overlap based on first display data and second display data.
